(19) United States
(12) Patent Application Publication
(10) Pub. No.: US 2012/0306298 A1
(43) Pub. Date: Dec. 6, 2012

(54) SWITCHED RELUCTANCE MOTOR

(75) Inventors: Changsung Sean Kim, Gyunggi-do (KR); Se Yeun Hwang, Gyunggi-do (KR); Chang Hwan Choi, Gyunggi-do (KR); Han Kyung Bae, Gyunggi-do (KR); Guen Hong Lee, Seoul (KR)

(73) Assignee: SAMSUNG ELECTRO-MECHANICS CO., LTD., Gyunggi-do (KR)

(21) Appl. No.: 13/340,285

(22) Filed: Dec. 29, 2011

(30) Foreign Application Priority Data
Jun. 2, 2011 (KR) 1020110053468
Jun. 3, 2011 (KR) 1020110054085

(51) Int. Cl. H02K 19/10

(52) U.S. Cl. 310/46

(57) ABSTRACT

Disclosed herein is a switched reluctance motor comprising: an outer rotor provided with a plurality of salient poles protruded at equidistance along an inner peripheral surface thereof; and a stator provided in the outer rotor, including a plurality of stator cores including a pair of stator salient poles protruded toward the salient pole of the outer rotor and a stator yoke connecting and supporting stator salient poles to each other, and having phase windings in which coils are wound around the stator salient poles, wherein a magnetic flux generated by applying a current to the phase winding flows through the pair of stator salient poles and the salient pole of the outer rotor.

### CROSS REFERENCE TO RELATED APPLICATION

This application claims the benefit of Korean Patent Application No. 10-2011-0054085, filed on Jun. 3, 2011, entitled “Switched Reluctance Motor”, Korean Patent Application No. 10-2011-0053468, filed Jun. 2, 2011, entitled “Switched Reluctance Motor”, which are hereby incorporated by reference in its entirety into this application.

### BACKGROUND OF THE INVENTION

1. Technical Field

The present invention relates to a switched reluctance motor.

2. Description of the Related Art

Recently, a demand for a motor has largely increased in various industries such as vehicles, aerospace, military, medical equipment, or the like. In particular, a cost of a motor using a permanent magnet is increased due to the sudden price increase of a rare earth material, such that a switched reluctance motor has become interested as a new alternative.

A driving principle of an SR motor rotates a rotor using a reluctance torque generated according to the change in magnetic reluctance.

As shown in FIG. 1, a switched reluctance motor 100 according to the prior art includes a rotor 110 and a stator 120, wherein the rotor 110 is provided with a plurality of rotor salient poles 111 and the stator 120 is provided with a plurality of stator salient poles 121 opposite to the rotor salient poles 111. Further, a coil 130 is wound around the stator salient poles 121.

Further, the rotor 110 is configured of only a core without any type of excitation device, for example, a winding of a coil or a permanent magnet.

Therefore, when current flows in the coil 130 from the outside, the rotor 110 generates the reluctance torque moving in the coil 130 direction by magnetic force generated from the coil 130, such that the rotor 110 rotates in a direction in which the reluctance of a magnetic circuit is minimized.

However, the switched reluctance motor 100 according to the prior art may lead to core loss since a magnetic flux passes through both of the stator 120 and the rotor 110.

### SUMMARY OF THE INVENTION

The present invention has been made in an effort to provide a switched reluctance motor including stator cores in a pi shape to make a path of a magnetic flux short so as to be able to reduce core loss, including a support filled between the stator cores and made of a non-magnetic material or an insulating material to be able to improve strength and reduce noise and vibration, and including cooling pipes inserted into the support and disposed between a plurality of stator cores to be able to accomplish a heat radiation effect even at the time of high-speed rotation.

According to a preferred embodiment of the present invention, there is provided a switched reluctance motor including: an outer rotor provided with a plurality of salient poles protruded at equidistance along an inner peripheral surface thereof; and a stator provided in the outer rotor, including a plurality of stator cores including a pair of stator salient poles protruded toward the salient pole of the outer rotor and a stator yoke connecting and supporting stator salient poles to each other, and having phase windings in which coils are wound around the stator salient poles, wherein a magnetic flux generated by applying a current to the phase winding flows through the pair of stator salient poles and the salient pole of the outer rotor.

The stator core may have a larger distance between one ends of the pair of stator salient poles coupled to the stator yoke than between the other ends thereof and have a pi (n) shape.

The stator core may include the pair of salient poles coupled to the stator yoke and disposed to be in parallel with each other and has a pi shape.

The stator core may have a larger area at one end of the pair of stator salient poles coupled to the stator yoke than at the other ends thereof in a cross section in an orthogonal direction of a rotating shaft around which the rotor rotates and has a pi shape.

The stator may further include supports filled between the plurality of stator cores and between the stator salient poles having the coils wound therearound.

The support may be made of a non-magnetic material or an insulating material.

The stator may further include cooling pipes inserted into the supports and disposed between the plurality of stator cores.

The outer rotor may further include a sound proofing material filled between the plurality of salient poles.

Six stator cores may be formed at equipitch with respect to a circumferential direction of the stator, the coils may be wound around the stator salient poles to form three-phase windings, and ten salient poles of the outer rotor may be formed at equipitch with respect to a circumferential direction of the outer rotor.

According to another preferred embodiment of the present invention, there is provided a switched reluctance motor including: an outer rotor provided with a plurality of salient poles protruded at equidistance along an inner peripheral surface thereof; and a stator provided in the outer rotor, including stator cores including a pair of stator salient poles protruded toward the salient pole of the outer rotor and a stator yoke connecting and supporting the pair of stator salient poles to each other, and having phase windings in which coils are wound around the stator salient poles, a plurality of pair of stator salient poles being connected to each other at equidistance with respect to a circumferential direction of the stator yoke having a circular cross section in an orthogonal direction of a rotating shaft of the outer rotor, wherein a magnetic flux generated by applying a current to the phase winding flows through the pair of stator salient poles and the salient pole of the outer rotor.

The stator yoke may include a blocking hole formed between the pair of stator salient poles and a pair of stator salient pole adjacent thereto.

The stator core may include a plurality of stator yokes, and the stator yoke may have the pair of stator salient poles connected to each other and supported thereby and have connection parts formed at both ends thereof.

The present invention has been made in an effort to provide a double rotor type switched reluctance motor including an in rotor and an out rotor, wherein the motor includes stator cores in a pi shape to make a path of a magnetic flux short so as to be able to reduce core loss and balance the path of magnetic flux, fills a support made of a non-magnetic material or an insulating material between the stator cores to be able to improve strength and reduce noise and vibration, and includes a cooling pipe inserted into the support and disposed between the plurality of stator cores to be able to obtain a heat radiation effect even at the time of high-speed rotation.

According to a preferred embodiment of the present invention, there is provided a switched reluctance motor, including: an out rotor provided with a plurality of salient poles protruded at equidistance along an inner peripheral surface thereof; an in rotor provided with a plurality of salient poles protruded at equidistance along an outer peripheral surface thereof; and a stator including a plurality of out stator cores that include a pair of out stator salient poles provided in the out rotor, which is provided in an inner peripheral portion thereof so as to rotate the in rotor, and protruded toward the out rotor salient poles and an out stator yoke connecting and supporting the out stator salient poles and a plurality of in stator cores that include a pair of in stator salient poles protruded toward the in rotor salient poles and an in stator yoke connecting and supporting the in stator salient poles and a phase winding of which coils are wound around the out stator salient poles and the in stator salient poles, respectively, wherein magnetic flux generated by applying current to the phase winding flows through the pair of out stator salient poles and the out rotor salient poles and the pair of in stator salient poles and the in rotor salient poles.

The out stator core may be configured to have a distance between ends of the pair of out stator salient poles coupled with the out stator yoke is longer than that between the other ends thereof and have a pi (π) shape.

The out stator core may be configured so that the pair of out stator salient poles coupled with the out stator yoke are disposed to be parallel with each and have a pi shape.

The out stator core may be configured so that in a cross section in an orthogonal direction of a rotating shaft in which the out rotor rotates, an area of ends of the pair of out stator salient poles coupled with the out stator yoke is larger than that of the other ends thereof and have a pi shape.

The pair of in stator salient poles of the in stator core may be disposed to be parallel with each other.

The stator may further include a support filled between the plurality of out stator cores, between the in stator cores, between the out stator salient poles around which coils are wound, and between the in stator salient poles around which coils are wound.

The support may be made of a non-magnetic material or an insulating material.

The stator may further include a cooling pipe that is inserted into the support and is disposed between the plurality of out stator cores.

Six out stator cores may be formed at equipitch along an outer peripheral surface thereof with respect to a circumferential direction of the stator, six in stator cores may be formed at equipitch along an inner peripheral surface thereof with respect to a circumferential direction of the stator, the coil may be wound around the out stator salient pole and the in stator salient pole, respectively, to form 3-phase winding, 10 out rotor salient poles may be formed at equipitch with respect to the circumferential direction of the out rotor, and 10 in rotor salient poles may be formed at equipitch with respect to the circumferential direction of the in rotor.

According to another preferred embodiment of the present invention, there is provided a switched reluctance motor, including: an out rotor provided with a plurality of salient poles protruded at equidistance along an inner peripheral surface thereof; an in rotor provided with a plurality of salient poles protruded at equidistance along an outer peripheral surface thereof; and a stator including a stator core that includes a pair of out stator salient poles provided in the out rotor, provided in an inner peripheral portion thereof so as to rotate the in rotor, and protruded toward the out rotor salient poles, a pair of in stator salient poles protruded toward the in rotor salient poles, and a stator yoke connecting and supporting the plurality of a pair of out stator salient poles and the plurality of a pair of in stator salient poles and having a phase winding of which coils are wound around the out stator salient poles and the in stator salient poles, respectively, wherein the pair of out stator salient poles and the pair of in stator salient poles are connected to each other in plural at equidistance with respect to a circumferential direction of the stator yoke in which a cross section in an orthogonal direction of a rotating shaft of the out rotor is a circular shape and the stator has the phase winding of which coils is wound around the stator salient poles.

Magnetic flux generated by applying current to the phase winding may flow through the pair of out stator salient poles and the out rotor salient poles and the pair of in stator salient poles and the in rotor salient poles.

The stator yoke may have blocking holes disposed between a pair of in stator salient poles adjacent to the pair of out stator salient poles.

The stator core may include a plurality of stator yokes and the stator yoke may connect and support the pair of out stator salient poles and has connection parts formed at both ends thereof.

The out rotor may further include a sound proofing material filled between the plurality of salient poles.

According to another preferred embodiment of the present invention, there is provided a switched reluctance motor, including: an out rotor provided with a plurality of salient poles protruded at equidistance along an inner peripheral surface thereof; an in rotor provided with a plurality of salient poles protruded at equidistance along an outer peripheral surface thereof; and a stator including a stator core that includes a pair of out stator salient poles provided in the out rotor, provided in an inner peripheral portion thereof so as to rotate the in rotor, and protruded toward the out rotor salient poles, a pair of in stator salient poles protruded toward the in rotor salient poles, and a stator yoke connecting and supporting the plurality of a pair of out stator salient poles and the plurality of a pair of in stator salient poles and having a phase winding of which coils are wound around the out stator salient poles and the in stator salient poles, respectively, wherein the pair of out stator salient poles and the pair of in stator salient poles are connected to each other in plural at equidistance with respect to a circumferential direction of the stator yoke in which a cross section in an orthogonal direction of a rotating shaft of the out rotor is a circular shape and the stator has the phase winding of which coils are wound around the stator yoke.

### BRIEF DESCRIPTION OF THE DRAWINGS

FIG. 1 is a schematic cross-sectional view of a switched reluctance motor according to the prior art;

FIG. 2 is a schematic cross-sectional view of a switched reluctance motor according to a first preferred embodiment of the present invention;

FIG. 3 is a perspective view of the switched reluctance motor shown in FIG. 2;

FIG. 4 is a cross-sectional view schematically showing a stator core according to a first preferred embodiment in the switched reluctance motor according to the present invention;

FIG. 5 is a cross-sectional view schematically showing a stator core according to a second preferred embodiment in the switched reluctance motor according to the present invention;

FIG. 6 is a cross-sectional view schematically showing a stator core according to a third preferred embodiment in the switched reluctance motor according to the present invention;

FIG. 7 is a cross-sectional view schematically showing a stator core according to a fourth preferred embodiment in the switched reluctance motor according to the present invention;

FIG. 8 is a cross-sectional view schematically showing a stator core according to a fifth preferred embodiment in the switched reluctance motor according to the present invention; and

FIG. 9 is a cross-sectional view schematically showing a rotor according to a preferred embodiment in the switched reluctance motor according to the present invention.

FIG. 10 is a schematic cross-sectional view of a switched reluctance motor according to a second preferred embodiment of the present invention.

FIG. 11 is a perspective view of the switched reluctance motor shown in FIG. 10.

FIG. 12 is a schematic cross-sectional view of a switched reluctance motor according to a third preferred embodiment of the present invention.

FIG. 13 is a schematic cross-sectional view of a switched reluctance motor according to a fourth preferred embodiment of the present invention.

FIG. 14 is a schematic cross-sectional view of a switched reluctance motor according to a fifth preferred embodiment of the present invention.

FIG. 15 is a schematic cross-sectional view of a switched reluctance motor according to a sixth preferred embodiment of the present invention.

FIG. 16 is a cross-sectional view schematically showing the out stator core according to the first preferred embodiment in the switched reluctance motor according to the present invention.

FIG. 17 is a cross-sectional view schematically showing the out stator core according to the second preferred embodiment in the switched reluctance motor according to the present invention.

FIG. 18 is a cross-sectional view schematically showing the out stator core according to the third preferred embodiment in the switched reluctance motor according to the present invention.

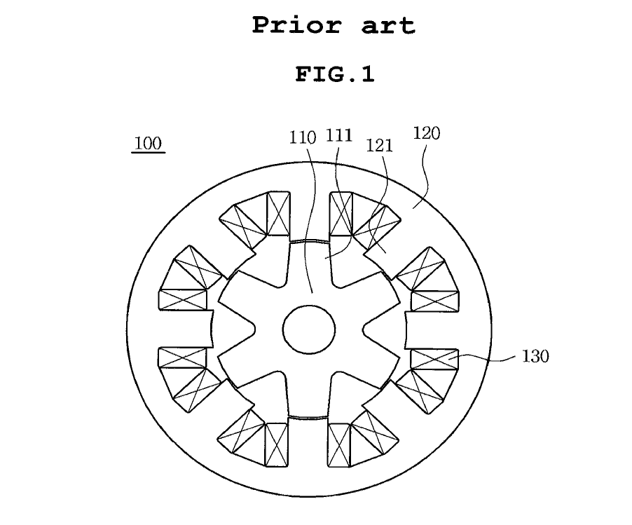

### DESCRIPTION OF THE PREFERRED EMBODIMENTS

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

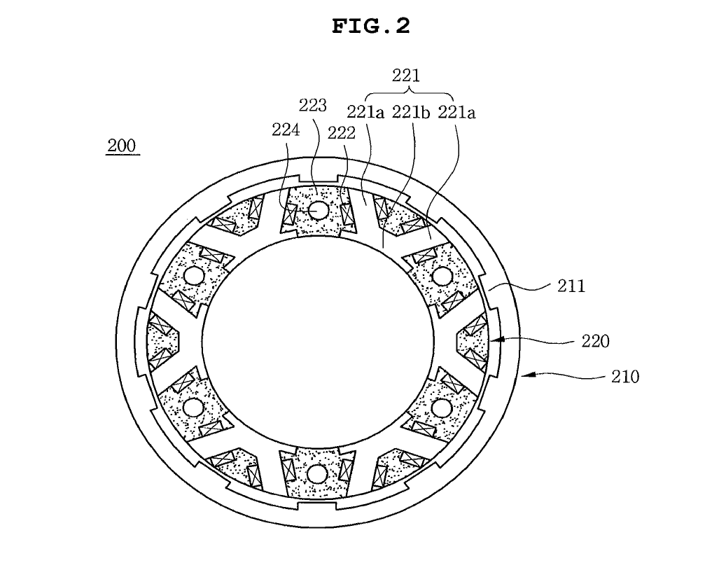

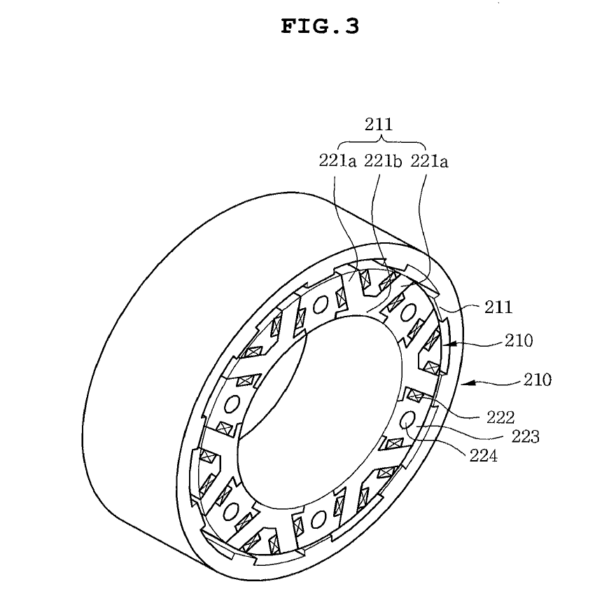

FIG. 2 is a schematic cross-sectional view of a switched reluctance motor according to a first preferred embodiment of the present invention; and FIG. 3 is a perspective view of the switched reluctance motor shown in FIG. 2. As shown, a switched reluctance motor 200 according to a first preferred embodiment of the present invention includes an outer rotor 210 and a stator 220, wherein the outer rotor 210 rotates in one direction by a reluctance torque with the stator 220.

More specifically, the outer rotor 210 is provided with a plurality of salient poles 211 protruded at equidistance along an inner peripheral surface thereof.

In addition, the stator 220 is provided in the outer rotor 210 and includes a plurality of stator cores 221, coils 222, supports 223, and cooling pipes 224.

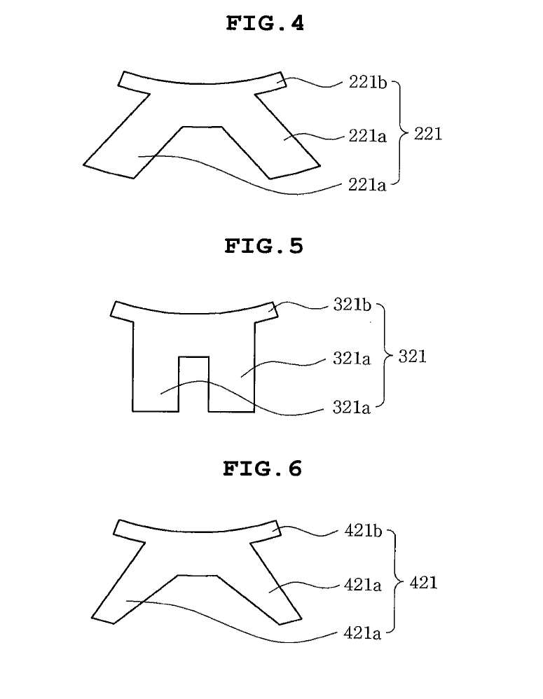

The stator core 221 includes a pair of stator salient poles 221a protruded toward the salient pole 211 of the outer rotor and a stator yoke 221b connecting and supporting one ends of the pair of stator salient poles 221a to each other and has a pi shape as shown in FIGS. 2 and 4. In addition, in the stator core 221 according to the first preferred embodiment, the pair of stator salient poles 221a is not in parallel with each other but has a larger distance between one ends of the stator salient poles 221a coupled to the stator yoke 221b than between the other ends thereof. Further, the pair of stator salient poles 221a is disposed so that the distance between the other ends thereof gradually increases as compared to the distance between one ends thereof.

In addition, each coil 222 is wound around the pair of stator salient poles 221a.

Furthermore, the supports 223 are filled between the plurality of stator cores 221 and between the stator salient poles 221a having the coil 222 wound therearound, such that strength of the stator 220 is improved and noise and vibration are reduced. Further, the support is made of a non-magnetic material or an insulating material.

The cooling pipes 224 are to discharge heat generated due to a high-speed operation and are disposed between the plurality of stator cores 221 in a state in which they are inserted into the support 223. In addition, the cooling pipe 224 may be implemented by a water cooling pipe in which water flows.

Through the above-mentioned configuration, in the switched reluctance motor 200 according to the present invention, the magnetic flux generated from the coil 222 excited due to current applied thereto flows from one of the pair of stator salient poles 221a of the stator core 221 through the salient pole 211 of the outer rotor 210 as shown by an arrow of FIG. 2 and flows to the other stator salient pole 221a. Through the above-mentioned configuration, the magnetic flux flows in a short path and core loss is reduced.

In addition, in the switched reluctance motor 200 according to the first preferred embodiment of the present invention, six stator cores 211 are formed at equipitch with respect to a circumferential direction of the stator 220, the coils 222 are wound around the stator salient poles 221a to form three-phase windings, and ten salient poles 211 of the outer rotor 210 are formed at equipitch with respect to a circumferential direction of the outer rotor 210.

In addition, the switched reluctance motor according to the present invention may also be implemented as a drainage structure in which twelve stator cores are formed at equipitch with respect to the circumferential direction of the stator and twenty salient poles of the outer rotor are formed at equipitch with respect to the circumferential direction of the outer rotor.

FIG. 5 is a cross-sectional view schematically showing a stator core according to a second preferred embodiment in the switched reluctance motor according to the present invention. As shown, a stator core 321 includes a pair of stator salient poles 321a protruded toward the salient poles of the outer rotor and a stator yoke 321b connecting and supporting one ends of the pair of stator salient poles 321a to each other and has a pi shape. In addition, the pair of the stator salient poles 321a of the stator core 321 according to the second preferred embodiment is disposed to be in parallel with each other, as compared with the stator salient poles 221a of the stator core 221 according to the first preferred embodiment. Through the above-mentioned configuration, it is possible to prevent the direction of magnetic flux from being deflected toward both directions of the stator salient poles 321a.

FIG. 6 is a cross-sectional view schematically showing a stator core according to a third preferred embodiment in the switched reluctance motor according to the present invention. As shown, a stator core 421 includes a pair of stator salient poles 421a protruded toward the salient poles of the outer rotor and a stator yoke 321b connecting and supporting one ends of the pair of stator salient poles 421a to each other and has a pi shape. In addition, the sizes of the stator salient poles 421a of the stator core 421 according to the third preferred embodiment are not constant, as compared with the stator salient poles 221a of the stator core 221 according to the first preferred embodiment. More specifically, an area of one ends of the stator salient poles 421a coupled to the stator yoke 421b is formed to be larger than that of the other ends thereof in a cross section in an orthogonal direction of a rotating shaft. Through the above-mentioned configuration, the magnetic flux flowing from the stator salient poles 421a to the salient poles of the outer rotor may be more concentrated.

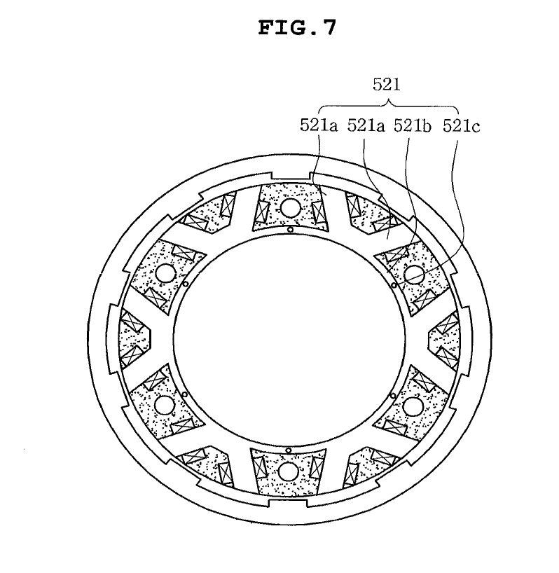

FIG. 7 is a cross-sectional view schematically showing a stator core according to a fourth preferred embodiment in the switched reluctance motor according to the present invention. As shown, a stator core 521 includes a pair of stator salient poles 521a protruded toward the salient poles of the outer rotor and a stator yoke 521b connecting and supporting one ends of the pair of stator salient poles 521a to each other. The stator yokes 521b of the stator core 521 according to the fourth preferred embodiment are connected integrally with each other rather than being formed in plural, as compared to the stator yoke 221b according to the first preferred embodiment, and has a circular cross section in an orthogonal direction of a rotating shaft of the rotor.

In addition, a plurality of pairs of stator salient poles 521a are disposed at equidistance with respect to a circumferential direction of the stator yoke 521b.

In addition, the stator yoke 521b includes a blocking hole 521c formed between the pair of stator salient poles 521a and a pair of stator salient poles 521a adjacent thereto. A phenomenon in which a magnetic flux deviates from its path may be blocked by the blocking hole 521c.

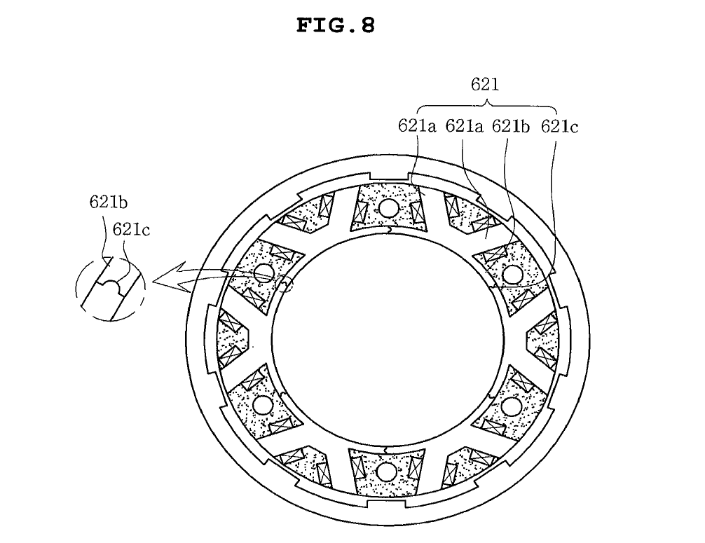

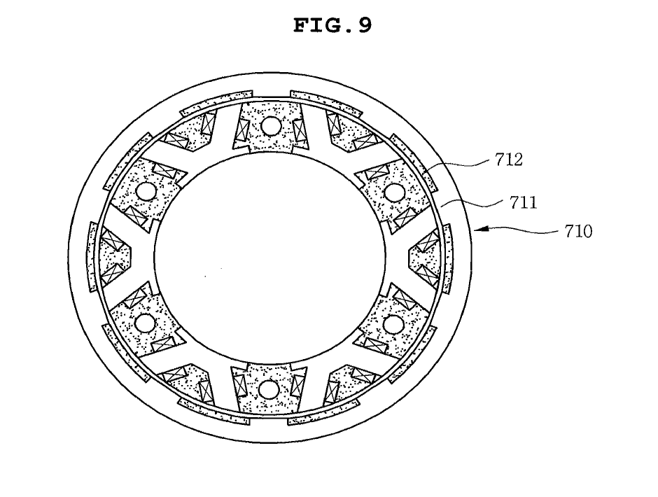

FIG. 8 is a cross-sectional view schematically showing a stator core according to a fifth preferred embodiment in the switched reluctance motor according to the present invention. As shown, a stator core 621 includes a pair of stator salient poles 621a protruded toward the salient poles of the outer rotor and a stator yoke 621b connecting and supporting one ends of the pair of stator salient poles 621a to each other. In addition, the stator yokes 621b of the stator core 621 according to the fifth preferred embodiment of the present invention are formed in plural, have connection parts 621c formed at both ends thereof, and are connected to each other so as to be integral with each other by the connection parts 621c, as compared to the stator yoke 521b according to the fourth preferred embodiment, thereby making it possible to implement the stator core 621 that is easily manufactured and has increased strength.

FIG. 9 is a cross-sectional view schematically showing an outer rotor according to a preferred embodiment in the switched reluctance motor according to the present invention. An outer rotor 710 is provided with a plurality of salient poles 711 protruded at equidistance along the inner peripheral surface thereof so that it is formed in an outer rotor type and further includes a sound proofing material 712 filled between the salient poles 712, wherein the sound proofing material 712 reduces noise and vibration.

As set forth above, according to the preferred embodiments of the present invention, it is possible to obtain the switched reluctance motor including the stator cores in the pi shape to make a path of a magnetic flux short so as to be able to reduce core loss, including the support filled between the stator cores and made of a non-magnetic material or an insulating material to be able to improve strength and reduce noise and vibration, and including the cooling pipes inserted into the support and disposed between the plurality of stator cores to be able to accomplish a heat radiation effect even at the time of high-speed rotation.

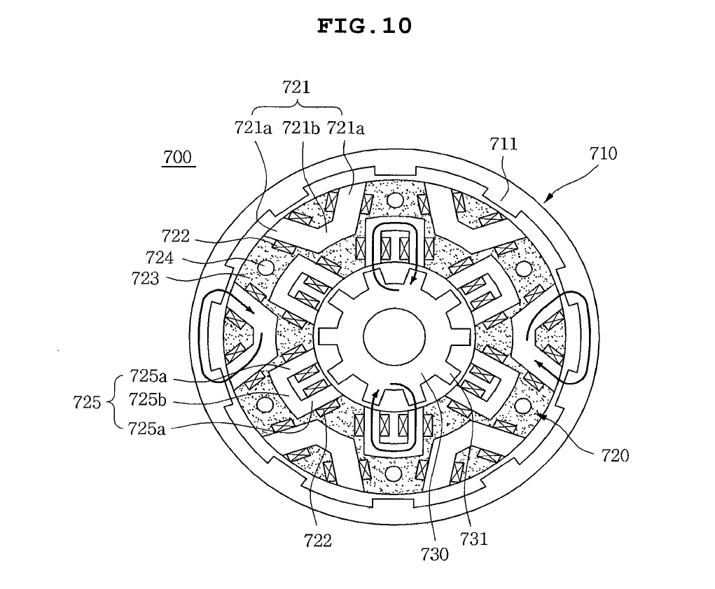

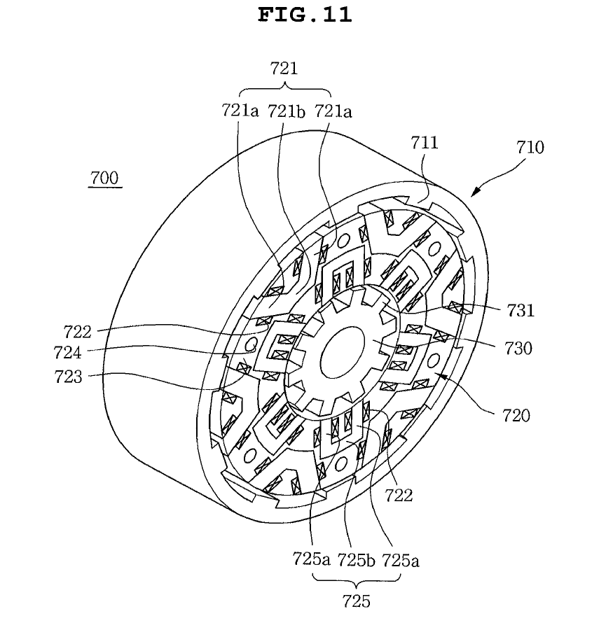

FIG. 10 is a cross-sectional view schematically showing a switched reluctance motor according to a second preferred embodiment of the present invention and FIG. 11 is a perspective view of the switched reluctance motor shown in FIG. 10. As shown, a switched reluctance motor 700 includes a double rotor type switched reluctance motor including an out rotor 710, a stator 720, and an in rotor 730. The out rotor 710 is disposed at an outer peripheral portion of the stator 720, the in rotor 730 is rotatably dispose at an inner peripheral portion of the stator 720, and the out rotor 710 and the in rotor 730 each rotates in one direction by reluctance talk with the stator 720.

In more detail, the out rotor 710 is provided with a plurality of salient poles 711 protruded at equidistance along an inner peripheral surface thereof. Further, the in rotor 730 is provided with a plurality of salient poles 731 protruded at equidistance along an outer peripheral surface thereof.

Further, the stator 720 is provided in the out rotor 710 and includes a plurality of out stator cores 721, a coil 722, a support 723, a cooling pipe 724, and an in stator core 725.

The out stator core 721 includes an out stator yoke 221b that connects and supports ends of a pair of out stator salient poles 721a protruded toward the salient poles 711 of the out rotor 710 and has a pi (π) shape. Further, each coil 722 is wound around the pair of out stator salient poles 721a.

The in stator core 725 includes a pair of in stator salient poles 725a protruded toward the salient poles 731 of the in rotor 730 and an in stator yoke 725b that connects and supports ends of the in stator salient poles 725a and has a pi (π) shape. In addition, the pair of in stator salient poles 725a are disposed to be parallel with each other. By this configuration, it is possible to prevent a direction of magnetic flux from being deflected in both directions of the in stator salient poles 725a.

Further, each coil 722 is wound around the pair of in stator salient poles 725a.

Further, the support 723 is filled between the plurality of out stator cores 721, between the in stator cores 725, between the out stator salient poles 721a around which the coil 722 is wound, and between the in stator salient poles 725a around which the coil 722 is wound. Further, the strength of the stator 720 is improved and the noise and vibration are reduced, by the support. In addition, the support is made of a non-magnetic material or an insulating material.

The cooling pipe 724 is to discharge heat due to a high-speed operation and is disposed between the plurality of out stator cores 721 in a state in which it is inserted into the support 723. In addition, the cooling pipe 724 may be implemented by a water cooling pipe in which water flows.

By the configuration, in the switched reluctance motor 700 according to the present invention, the magnetic flux generated from the coil 722 excited due to current applied thereto flows through the salient pole 711 of the out rotor 710 from one of the pair of out stator salient poles 721a of the out stator core 721 as shown by an arrow of FIG. 10 and flows in the other out stator salient pole 721a.

Further, the magnetic flux flows through the salient pole 731 of the in rotor 730 from one of the pair of in stator salient poles 725a of the in stator core 725 and flows in the other in stator salient pole 725a.

By this configuration, the core loss can be reduced due to the magnetic flux of the short path flowing in both the out rotor 710 and the in rotor 730, the high-efficiency torque and output can be obtained and the flowing of magnetic flux can be balanced, due to the implementation of the double rotor.

In addition, the out rotor may further include a sound proofing material (not shown) filled between the plurality of salient poles, wherein the sound proofing material is made of a non-magnetic material or an insulating material.

In addition, in the switched reluctance motor 700 according to the first embodiment of the present invention, six out stator cores 211 are formed at equipitch along an outer peripheral surface thereof with respect to a circumferential direction of the stator 720, six in stator cores 715 are formed at equipitch along an inner peripheral surface thereof with respect to a circumferential direction of the stator 720, the coil 722 is wound around the out stator salient pole 721a and the in stator salient pole 725a, respectively, to form 3-phase winding, 10 salient poles 711 of the out rotor 710 are formed at equipitch with respect to the circumferential direction of the out rotor 710, 10 salient poles 731 of the in rotor 730 are formed at equipitch with respect to the circumferential direction of the in rotor 730.

In addition, the switched reluctance motor according to the present invention may be implemented as a drainage structure in which 12 in stator cores and 12 out stator cores are formed at equipitch with respect to the circumferential direction of the stator and 20 out rotor salient poles and in rotor salient poles are each formed at equipitch with respect to the circumferential direction.

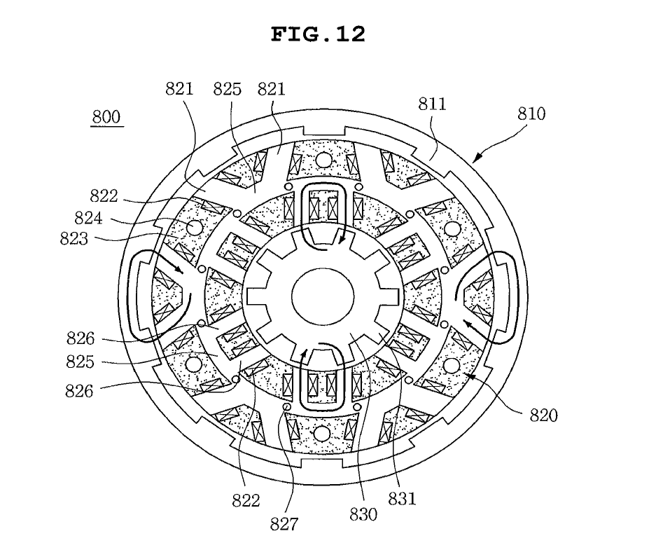

FIG. 12 is a schematic cross-sectional view of a switched reluctance motor according to a third preferred embodiment of the present invention. As shown, a switched reluctance motor 800 has the same technical configuration as compared with the switched reluctance motor 700 according to the second preferred embodiment shown in FIG. 10 other than only the stator yoke connecting the stator salient poles of the stator core.

In more detail, a stator 820 of the switched reluctance motor according to the second preferred embodiment of the present invention includes a stator yoke 825 that connects and supports ends of the pair of out stator salient poles 821 protruded toward the salient poles 811 of the out rotor 810 and connects and supports ends of the pair of in stator salient poles 826 protruded toward salient poles 831 of the in rotor 830. That is, comparing with the stator yoke 721b according to the second preferred embodiment, the stator yoke 825 are integrally connected rather than being separated in plural and a cross section in an orthogonal direction of a rotating shaft is formed in a circular shape.

The stator yoke 825 has blocking holes 827 disposed between the pair out stator salient poles 821 and the pair of in stator salient poles 826. The blocking hole 827 controls the flow of magnetic flux to block the path separation of magnetic flux.

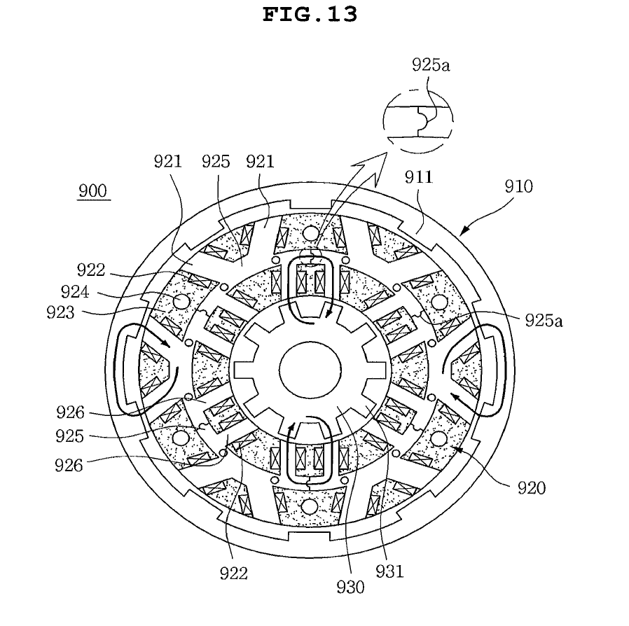

FIG. 13 is a schematic cross-sectional view of a switched reluctance motor according to a forth preferred embodiment of the present invention. As shown, a switched reluctance motor 900 has the same technical configuration as compared with the switched reluctance motor 800 according to the third preferred embodiment shown in FIG. 12 other than only the stator yoke connecting the stator salient poles of the stator core.

In more detail, a stator 920 of the switched reluctance motor according to the third preferred embodiment of the present invention includes a plurality of stator yokes 925, wherein the stator yoke 925 connects and supports ends of the pair of out stator salient poles 921 protruded toward the salient poles 911 of the out rotor 910 and connects and supports ends of the pair of in stator salient poles 926 protruded toward the salient poles 931 of the in rotor 930. Further, a connection part 925a is formed between the out stator salient poles 921 and the stator yokes 925 are integrally connected by a connection part 925a, such that the stator 920 has increased rigidity while being easily manufactured.

FIG. 14 is a schematic cross-sectional view of a switched reluctance motor according to a fifth preferred embodiment of the present invention. As shown, the switched reluctance motor 1000 has the same technical configuration as compared with the switched reluctance motor 800 according to the third preferred embodiment shown in FIG. 12 other than only the position and object of the coil wound.

In more detail, in a switched reluctance motor 1000, a coil 1022 is wound around a stator yoke 1025.

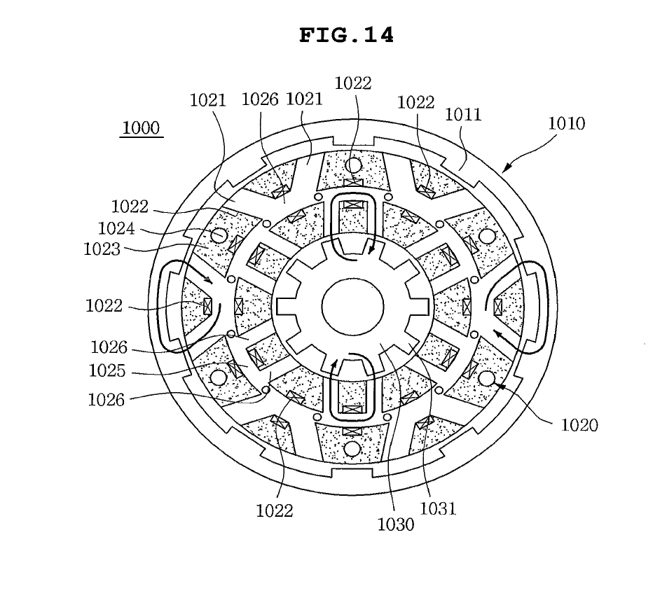

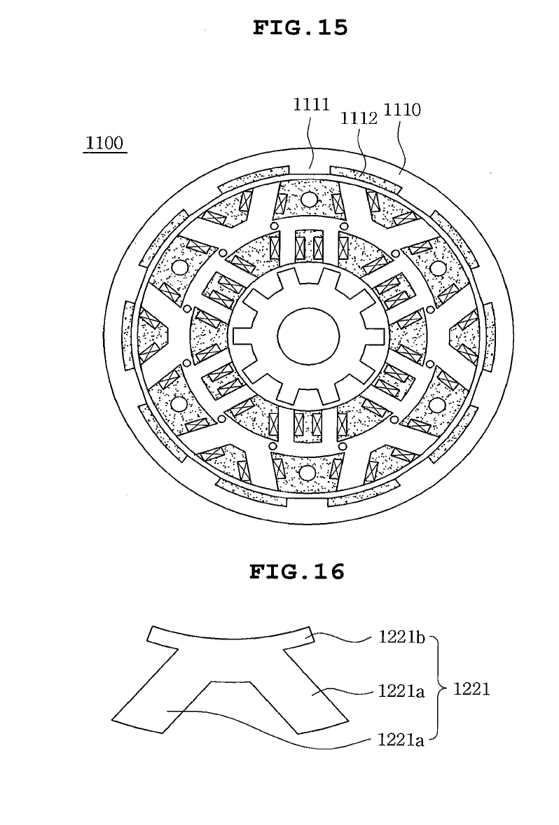

FIG. 15 is a schematic cross-sectional view of a switched reluctance motor according to a sixth preferred embodiment of the present invention. As shown, a switched reluctance motor 1100 has the same technical configuration as compared with the switched reluctance motor 800 according to the third preferred embodiment shown in FIG. 12 other than only the out rotor.

In more detail, an out rotor 1110 is provided with a plurality of salient poles 1111 protruded at equidistance along the inner peripheral surface thereof and further includes a sound proofing material 1112 filled between the salient poles 1111, which reduces noise and vibration by the sound proofing material 1112.

FIG. 16 is a cross-sectional view schematically showing the out stator core according to the first preferred embodiment in the switched reluctance motor according to the present invention. As shown, an out stator core 1221 includes the pair of out stator salient poles 1221a and the out stator yoke 1221b that connects and supports ends of the out stator salient poles 1221a and has the pi (π) shape. Further, in the out stator core 1221, the pair of stator salient poles 1221a are not in parallel with each other. In this case, a distance between the ends of the stator salient poles 1221a coupled with the stator yoke 1221b is longer than a distance between the other ends there of coupled with the stator yoke 1221b. Further, the out stator core 1221 is disposed so that the distance between ends is to be longer and longer than the distance between the other ends.

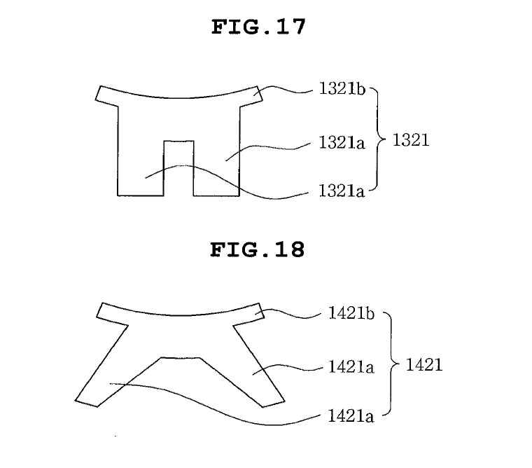

FIG. 17 is a cross-sectional view schematically showing the out stator core according to the second preferred embodiment in the switched reluctance motor according to the present invention. As shown, an out stator core 1321 includes a pair of out stator salient poles 1321a protruded toward the out rotor salient poles and an out stator yoke 1321b that connects and supports the ends of the pair of out stator salient poles 1321a and has a pi (π) shape. In addition, the pair of stator salient poles 1321a of the out stator core 1321 according to the second preferred embodiment are disposed to be parallel with each other, as compared with the stator salient poles 1321a of the stator core 821 according to the first preferred embodiment. By this configuration, it is possible to prevent the direction of magnetic flux from being deflected in both directions of the stator salient poles 1321a.

FIG. 18 is a cross-sectional view schematically showing the out stator core according to the third preferred embodiment in the switched reluctance motor according to the present invention. As shown, an out stator core 1421 includes a pair of out stator salient poles 1421a protruded toward the out rotor salient poles and an out stator yoke 1421b that connects and supports ends of the pair of out stator salient poles 1421a and has a pi (π) shape. In addition, the size of the stator salient poles 1421a of the stator core 1421 according to the third preferred embodiment are not constant, as compared with the out stator salient poles 1221a of the out stator core 1221 according to the first preferred embodiment. In more detail, an area of one end of the out stator salient pole 1421a coupled with the out stator yoke 1421b is formed to be larger than that of the other ends thereof, in the cross section in the orthogonal direction of the rotating shaft. By this configuration, the magnetic flux flowing from the out stator salient poles 921a to the out rotor salient poles can be more concentrated.

The present invention can provide the double rotor type switched reluctance motor including the in rotor and the out rotor, wherein the motor includes stator cores in a pi shape to make the path of magnetic flux short so as to be able to reduce the core loss and balance the path of magnetic flux, fills the support made of the non-magnetic material or the insulating material between the stator cores to be able to improve the strength and reduce the noise and the vibration, and includes the cooling pipe inserted into the support and disposed between the plurality of stator cores to be able to obtain the heat radiation effect even at the time of high-speed rotation.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A switched reluctance motor comprising:
an outer rotor provided with a plurality of salient poles protruded at equidistance along an inner peripheral surface thereof; and
a stator provided in the outer rotor, including a plurality of stator cores including a pair of stator salient poles protruded toward the salient pole of the outer rotor and a stator yoke connecting and supporting stator salient poles to each other, and having phase windings in which coils are wound around the stator salient poles,
wherein a magnetic flux generated by applying a current to the phase winding flows through the pair of stator salient poles and the salient pole of the outer rotor.

2. The switched reluctance motor as set forth in claim 1, wherein the stator core has a larger distance between one ends of the pair of stator salient poles coupled to the stator yoke than between the other ends thereof and has a pi (π) shape.

3. The switched reluctance motor as set forth in claim 1, wherein the stator core includes the pair of salient poles coupled to the stator yoke and disposed to be in parallel with each other and has a pi shape.

4. The switched reluctance motor as set forth in claim 1, wherein the stator core has a larger area at one end of the pair of stator salient poles coupled to the stator yoke than at the other ends thereof in a cross section in an orthogonal direction of a rotating shaft around which the rotor rotates and has a pi shape.

5. The switched reluctance motor as set forth in claim 1, wherein the stator further includes supports filled between the plurality of stator cores and between the stator salient poles having the coils wound therearound.

6. The switched reluctance motor as set forth in claim 5, wherein the support is made of a non-magnetic material or an insulating material.

7. The switched reluctance motor as set forth in claim 5, wherein the stator further includes cooling pipes inserted into the supports and disposed between the plurality of stator cores.

8. The switched reluctance motor as set forth in claim 1, wherein the outer rotor further includes a sound proofing material filled between the plurality of salient poles.

9. The switched reluctance motor as set forth in claim 1, wherein six stator cores are formed at equipitch with respect to a circumferential direction of the stator, the coils are wound around the stator salient poles to form three-phase windings, and ten salient poles of the outer rotor are formed at equipitch with respect to a circumferential direction of the outer rotor.

10. A switched reluctance motor comprising:
an outer rotor provided with a plurality of salient poles protruded at equidistance along an inner peripheral surface thereof; and
a stator provided in the outer rotor, including stator cores including a pair of stator salient poles protruded toward the salient pole of the outer rotor and a stator yoke connecting and supporting the pair of stator salient poles to each other, and having phase windings in which coils are wound around the stator salient poles, a plurality of pair of stator salient poles being connected to each other at equidistance with respect to a circumferential direction of the stator yoke having a circular cross section in an orthogonal direction of a rotating shaft of the outer rotor,
wherein a magnetic flux generated by applying a current to the phase winding flows through the pair of stator salient poles and the salient pole of the outer rotor.

11. The switched reluctance motor as set forth in claim 10, wherein the stator yoke includes a blocking hole formed between the pair of stator salient poles and a pair of stator salient poles adjacent thereto.

12. The switched reluctance motor as set forth in claim 10, wherein the stator core includes a plurality of stator yokes, and
the stator yoke has the pair of stator salient poles connected to each other and supported thereby and has connection parts formed at both ends thereof.

13. A switched reluctance motor, comprising:
an out rotor provided with a plurality of salient poles protruded at equidistance along an inner peripheral surface thereof;
an in rotor provided with a plurality of salient poles protruded at equidistance along an outer peripheral surface thereof; and
a stator including a plurality of out stator cores that include a pair of out stator salient poles provided in the out rotor, provided in an inner peripheral portion thereof so as to rotate the in rotor, and protruded toward the out rotor salient poles and an out stator yoke connecting and supporting the out stator salient poles and a plurality of in stator cores that include a pair of in stator salient poles protruded toward the in rotor salient poles and an in stator yoke connecting and supporting the in stator salient poles and a phase winding of which coils are wound around the out stator salient poles and the in stator salient poles, respectively,
wherein magnetic flux generated by applying current to the phase winding flows through the pair of out stator salient poles and the out rotor salient poles and the pair of in stator salient poles and the in rotor salient poles.

14. The switched reluctance motor as set forth in claim 13, wherein the out stator core is configured to have a distance between ends of the pair of out stator salient poles coupled with the out stator yoke longer than that between the other ends thereof and has a pi (π) shape.

15. The switched reluctance motor as set forth in claim 13, wherein the out stator core is configured so that the pair of out stator salient poles coupled with the out stator yoke are disposed to be parallel with each and has a pi shape.

16. The switched reluctance motor as set forth in claim 13, wherein the out stator core is configured so that in a cross section in an orthogonal direction of a rotating shaft in which the out rotor rotates, an area of ends of the pair of out stator salient poles coupled with the out stator yoke is larger than that of the other ends thereof and has a pi shape.

17. The switched reluctance motor as set forth in claim 13, wherein the pair of in stator salient poles of the in stator core is disposed to be parallel with each other.

18. The switched reluctance motor as set forth in claim 13, wherein the stator further includes a support filled between the plurality of out stator cores, between the in stator cores, between the out stator salient poles around which coils are wound, and between the in stator salient poles around which coils are wound.

19. The switched reluctance motor as set forth in claim 18, wherein the support is made of a non-magnetic material or an insulating material.

20. The switched reluctance motor as set forth in claim 18, wherein the stator further includes a cooling pipe that is inserted into the support and is disposed between the plurality of out stator cores.

21. The switched reluctance motor as set forth in claim 13, wherein 6 out stator cores are formed at equipitch along an outer peripheral surface thereof with respect to a circumferential direction of the stator, 6 in stator cores are formed at equipitch along an inner peripheral surface thereof with respect to a circumferential direction of the stator, the coil is wound around the out stator salient pole and the in stator salient pole, respectively, to form 3-phase winding, 10 out rotor salient poles are formed at equipitch with respect to the circumferential direction of the out rotor, and 10 in rotor salient poles are formed at equipitch with respect to the circumferential direction of the in rotor.

22. A switched reluctance motor, comprising:
an out rotor provided with a plurality of salient poles protruded at equidistance along an inner peripheral surface thereof;
an in rotor provided with a plurality of salient poles protruded at equidistance along an outer peripheral surface thereof; and
a stator including a stator core that includes a pair of out stator salient poles provided in the out rotor, provided in an inner peripheral portion thereof so as to rotate the in rotor, and protruded toward the out rotor salient poles, a pair of in stator salient poles protruded toward the in rotor salient poles, and a stator yoke connecting and supporting the plurality of a pair of out stator salient poles and the plurality of a pair of in stator salient poles and having a phase winding of which coils are wound around the out stator salient poles and the in stator salient poles, respectively,
wherein the pair of out stator salient poles and the pair of in stator salient poles are connected to each other in plural at equidistance with respect to a circumferential direction of the stator yoke in which a cross section in an orthogonal direction of a rotating shaft of the out rotor is a circular shape and the stator has the phase winding of which coils are wound around the stator salient poles.

23. The switched reluctance motor as set forth in claim 22, wherein magnetic flux generated by applying current to the phase winding flows through the pair of out stator salient poles and the out rotor salient poles and the pair of in stator salient poles and the in rotor salient poles.

24. The switched reluctance motor as set forth in claim 22, wherein the stator yoke has blocking holes disposed between a pair of in stator salient poles adjacent to the pair of out stator salient poles.

25. The switched reluctance motor as set forth in claim 22, wherein the stator core includes a plurality of stator yokes, and
the stator yoke connects and supports the pair of out stator salient poles and has connection parts formed at both ends thereof.

26. The switched reluctance motor as set forth in claim 22, wherein the out rotor further includes a sound proofing material filled between the plurality of salient poles.

27. A switched reluctance motor, comprising:
an out rotor provided with a plurality of salient poles protruded at equidistance along an inner peripheral surface thereof;
an in rotor provided with a plurality of salient poles protruded at equidistance along an outer peripheral surface thereof; and
a stator including a stator core that includes a pair of out stator salient poles provided in the out rotor, provided in an inner peripheral portion thereof so as to rotate the in rotor, and protruded toward the out rotor salient poles, a pair of in stator salient poles protruded toward the in rotor salient poles, and a stator yoke connecting and supporting the plurality of a pair of out stator salient poles and the plurality of a pair of in stator salient poles and having a phase winding of which coils are wound around the out stator salient poles and the in stator salient poles, respectively,
wherein the pair of out stator salient poles and the pair of in stator salient poles are connected to each other in plural at equidistance with respect to a circumferential direction of the stator yoke in which a cross section in an orthogonal direction of a rotating shaft of the out rotor is a circular shape and the stator has the phase winding of which coils are wound around the stator yoke.
